(19) United States
(12) Patent Application Publication
(10) Pub. No.: US 2026/0118948 A1
(43) Pub. Date: Apr. 30, 2026

(54) COMBINED REALITY SYSTEM AND METHODS

(71) Applicant: Jacin John Steele, Highlands Ranch, CO (US)

(72) Inventor: Jacin John Steele, Highlands Ranch, CO (US)

(21) Appl. No.: 19/367,969

(22) Filed: Oct. 24, 2025

Related U.S. Application Data
(60) Provisional application No. 63/712,783, filed on Oct. 28, 2024.

(51) Int. Cl. G06F 3/01; G08B 21/02; G08B 21/18

(52) U.S. Cl. CPC G06F 3/011; G08B 21/02; G08B 21/182

(57) ABSTRACT

A combined reality system includes a physical representation of an object capable of physical interaction with a user; a virtual reality device including a processing element and configured to display a virtual representation of the object. The processing element is configured to merge the physical representation and the virtual representation to create a combined reality simulation.

### CROSS REFERENCE TO RELATED APPLICATIONS

This application claims the benefit of priority under 35 U.S.C. § 119(e) and 37 C.F.R. § 1.78 to provisional application No. 63/712,783 filed on Oct. 28, 2024, titled “Combined Reality System and Methods” which is hereby incorporated by reference herein in its entirety.

### BACKGROUND

In current virtual reality, augmented reality, mixed reality and similar systems (collectively or individually “VR” systems) a user's senses of sight and sound are adequately provided for by existing VR headsets. However, these systems fall short of combining the sense of touch with the sight and sound to complete an immersive experience. While current VR systems have small features (e.g., haptic motors) that can provide a sense of touch, such as holding a virtual blaster, such systems are inadequate to create truly immersive environments that combine sight, sound, and touch to simulate significant sensations as people would experience in their everyday lives.

### BRIEF SUMMARY

In one embodiment, a combined reality system includes: a physical representation of an object capable of physical interaction with a user; a virtual reality device including a processing element and configured to display a virtual representation of the object, wherein: the processing element is configured to merge the physical representation and the virtual representation to create a combined reality simulation.

Optionally, in some embodiments, the processing element is configured to execute a touch proximity correction method to prevent loss of combined immersion events by monitoring proximity and adjusting interactions between the user, the physical representation, and the virtual representation.

Optionally, in some embodiments, the processing element is configured calculate a safe zone based on the estimated time for the virtual representation or physical representation to reach a location of the user.

Optionally, in some embodiments, the processing element adjusts a speed of the virtual representation speed to match a movement capability of the physical representation.

Optionally, in some embodiments, the system further includes a sensor configured to detect a movement of the user and adjust movements of at least one of the virtual representation or the physical representation in response to the detected movement.

Optionally, in some embodiments, the physical representation includes a heat source configured to simulate a temperature of the object.

Optionally, in some embodiments, the processing element is configured to establish safe zones for the virtual representation and the physical representation relative to the user.

Optionally, in some embodiments, the processing element is configured to determine a risk gradient within the safe zones for prioritizing corrective actions of the physical representation or the virtual representation.

Optionally, in some embodiments, the processing element is configured to issue an alert to the user in case of a potential loss of combined immersion event.

Optionally, in some embodiments, the virtual representation is modifiable based on a user input.

Optionally, in some embodiments, the modification includes a visual modification.

In one embodiment, a method for providing an immersive combined reality experience, including: displaying, via a virtual reality device, a virtual representation of an object; providing, via the virtual reality device, a physical representation of the object capable of a physical interaction with a user; merging the virtual representation and physical representation to create a combined reality simulation.

Optionally, in some embodiments, the method further includes monitoring and correcting proximity between the user, the physical representation, and the virtual representation to prevent a loss of combined immersion event.

Optionally, in some embodiments, the method further includes determining, via the processing element, at least one safe zone based on an estimated time for the virtual representation or physical representation to reach a location of the user.

Optionally, in some embodiments, the method further includes determining, via the processing element, at least one safe zone based on an estimated time for the virtual representation or physical representation to reach a location of the other of the physical representation or the virtual representation.

In one embodiment, a system for avoiding a loss of combined immersion (LOCI) event in a combined reality simulation, includes: a user device with a display configured to display a virtual representation of an object; a physical representation of the object providing resistive force and interactive feedback to the user; a control system configured to: establish safe zones for the virtual representation and the physical representation relative to the user, and dynamically adjust the positions of the virtual representation and physical representation to maintain user immersion.

Optionally, in some embodiments, the control system is configured to determine a risk gradient within the safe zones for prioritizing corrective actions of the physical representation or the virtual representation.

Optionally, in some embodiments, the method further includes instructing the physical representation to move to a predefined safe location to avoid a LOCI event.

In one embodiment, a method of avoiding a loss of combined immersion (LOCI) event in a combined reality simulation, includes: establishing, via a processing element, a first safe zone with respect to a physical representation of a physical object; establishing, via the processing element, a second safe zone with respect to a virtual representation of the physical object; determining, via the processing element, a violation of either the first safe zone or the second zone based on a movement of the physical representation, the virtual representation, or a user of the combined reality simulation.

Optionally, in some embodiments the method further includes instructing, via the processing element, the virtual representation and/or physical representation to move closer to or farther away from the user.

Optionally, in some embodiments the method further includes instructing, via the processing element, the virtual representation and/or physical representation to move closer to or farther away from the other of the physical representation and/or the virtual representation.

Optionally, in some embodiments the method further includes instructing, via the processing element, the virtual representation and/or physical representation to alert the user that the user should stop approaching the virtual representation or the physical representation.

Optionally, in some embodiments the method further includes instructing, via the processing element, the virtual representation and/or physical representation to reorient themselves to match an orientation of the other of the physical representation and/or the virtual representation.

Optionally, in some embodiments the method further includes instructing, via the processing element, the virtual representation and/or physical representation to stop a current action.

### BRIEF DESCRIPTION OF THE DRAWINGS

FIG. 1A is a schematic of an embodiment of a combined reality system.

FIG. 1B is an example of a user field of view generated by the combined reality system of FIG. 1A.

FIG. 2A-FIG. 2C are examples of a process of merger of an example of a physical representation and an example of a virtual representation of the combined reality system of FIG. 1A.

FIG. 3 is a schematic of an example of safety zones for a virtual representation and a physical representation of the combined reality system of FIG. 1A.

FIG. 4A is a schematic of an example of a safety zone threshold for a physical representation of the combined reality system of FIG. 1A.

FIG. 4B is a schematic of an example of a safety zone threshold for a physical representation of the combined reality system of FIG. 1A.

FIG. 5 is a flowchart of a touch proximity correction method suitable for use with the system of FIG. 1A.

FIG. 6 is a schematic of an example of a method of using the combined reality system of FIG. 1A.

FIG. 7 is a simplified block diagram of components of a computing system of the combined reality system of FIG. 1A.

### DETAILED DESCRIPTION

Systems and methods disclosed herein provide for an immersive combined reality experience. The disclosure provides for the merger of a physical representation of a physical object such as an animal, a person, a plant, etc., with a virtual representation of the object. Thus, the disclosed systems and methods provide for an immersive experience that includes the senses of sight, sound, and touch.

The disclosed systems provide more than a cursory touch or feel by a user, such as a vibration felt by a haptic actuator or the like of existing VR systems. The disclosure provides a significant resistive force from a physical representation of an object merged, or mergeable with the virtual representation of the object in a combined reality system (“CR” or “CR system”). As used herein, the term “merger” means the co-location or coincidence of a physical representation in the real world with a virtual representation of an object in a virtual world, such that the two representations are perceivable as being a unified object. As used herein, “object” can be any physical or virtual matter, person, plant, location, etc. In the examples disclosed herein, the example object is that of a service animal such as a dog. However, all other types of objects are considered within the scope of this disclosure.

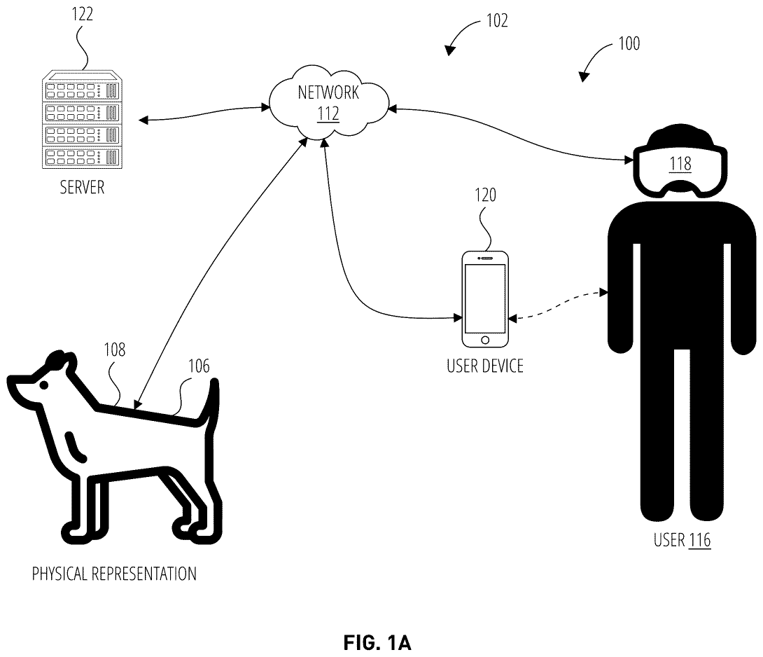

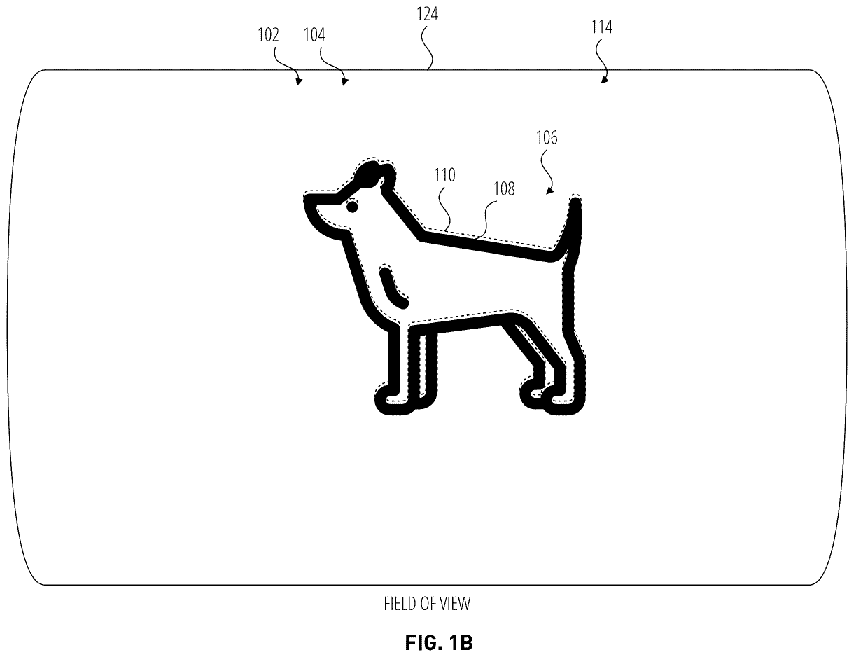

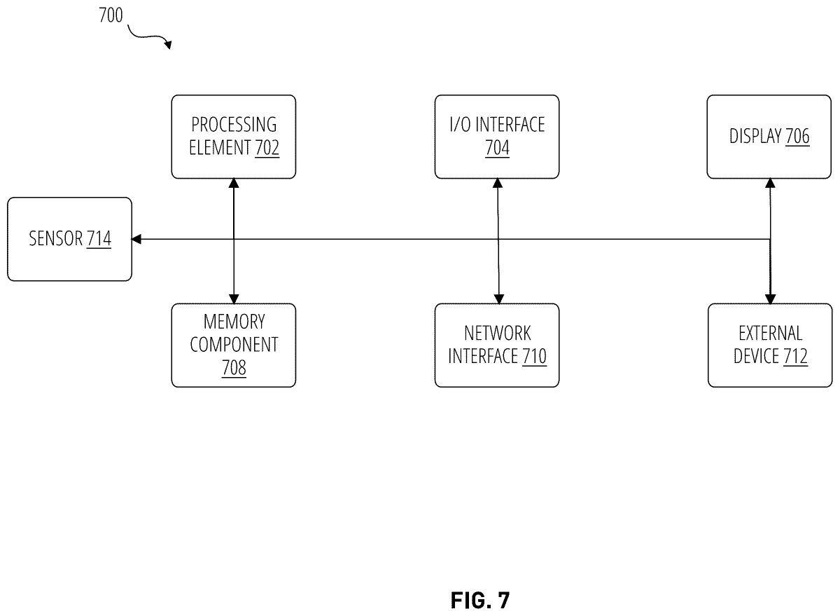

Turning to the figures, FIG. 1A-FIG. 1B show an example of a combined reality system 100. The combined reality system 100 includes a VR device 118 such as a virtual reality headset described in more detail with respect to FIG. 7. The combined reality system 100 may optionally include a server 122, a user device 120 such as a phone, tablet, smart watch, laptop, desktop, etc. The devices of the combined reality system 100 may be in communication with one another either directly or via a network 112.

The combined reality system includes a physical representation 108 and a virtual representation 110 of an object 106, in this example, a service dog. The physical representation 108 may be a robotic dog that can move about the physical world 102. Likewise, the virtual representation 110 may move about the virtual world 104. In many embodiments, the physical representation 108 and virtual representation 110 are merged into a single representation in a combined reality simulation 114, see, e.g., FIG. 1B.

The physical representation 108 is typically in close proximity to the user 116, such that the user 116 can touch, or otherwise interact with, the physical representation 108. In other embodiments, the physical representation 108 may be a more passive object than a robot, such as a doll, stuffed plush toy, inflatable toy, or the like.

The physical representation 108 has a general physical appearance similar to that of a real object 106. For example, the physical representation 108 may have the general appearance of a dog, such as having four legs and a tail. In some embodiments, the physical representation 108 may have a skin like that of a dog including fur. In some embodiments, the physical representation 108 may have a different skin than that of a real dog, such as a plastic or elastomeric skin, and the simulation of fur is provided by the virtual representation 110. In some embodiments, the physical representation 108 may include a heat source such that the physical representation 108 is warm to the touch like a real dog. In some embodiments, the physical representation 108 may include other structures found on a real object 106 (e.g., a mouth in the example of the dog). In some embodiments, the structures of the physical representation 108 may emit a fluid similar to that of a real object 106 (e.g., the robot dog physical representation 108 may have a mouth or tongue that can slobber on the user 116).

Continuing the example of the service dog, where the physical representation 108 is a robot, and the virtual representation 110 is a virtual service dog, the combined reality system 100 can simulate an immersive combined reality experience beneficial to the user 116 in ways not possible with existing VR systems. For example, the user 116 can lean against the physical representation 108 for stability, such as when the user 116 is exhibiting behaviors of an impending fall. Thus, the combined reality system 100 provides benefits that cannot be realized by existing technology such as a haptic suit. Using the combined reality system 100, a user 116 may be able to have an initial physical sensation of the physical representation 108 leaning against their leg. With a haptic suit the user 116 could fall and the virtual service dog would be of no benefit. With the combined reality system 100, the physical representation 108 robotic dog could provide resistive force that can support some or all of the user's 116 weight and/or press against the user 116 to prevent the fall.

In other embodiments, the physical representation 108 may have other physical interactions with the user 116 without limit. The physical representation 108 may interact with any portion of the user's 116 body. The interactions may be adjusted as desired by the user 116 or by the system 100 based on the type of object 106 represented by the physical representation 108 and virtual representation 110.

To achieve the combined reality simulation 114, the combined reality system 100 serves the user's 116 senses of sight and touch by different parts of the combined reality system 100. In many embodiments, neither the physical representation 108 nor the virtual representation 110 completely simulates the object 106. In other words, each of the physical representation 108 and the virtual representation 110 simulates a portion of the object 106. For example, a physical representation 108 (e.g., a robotic dog) may not be as attractive as a real object 106 (e.g., a robot is not as cuddly as a real dog) and doesn't replicate the look or movement of a real object 106. While a robotic service dog that helps prevent users from falling could be highly beneficial, users may not want a robot to be their companion, as it may be difficult to form an emotional bond with a robot. The virtual representation 110 may provide features of the object 106 that are not implemented or cannot be implemented by the physical representation 108. For example, the virtual representation 110 may simulate the fur of the dog. Furthermore, the user 116 may change one or more features of the virtual representation 110 to change the overall combined reality simulation 114 without the expense and delay of changing the physical representation 108. For example, the combined reality system 100 may include different profiles of dog breeds or other information such that the user 116 can change one or more features of the virtual representation 110 with a simple input to the VR device 118. For example, the user 116 could change the dog's breed, fur color, eye color, proportions of the body (e.g., longer legs, brachycephalic face, etc.). The VR device 118 can then display the modified virtual representation 110 and merge it with the physical representation 108.

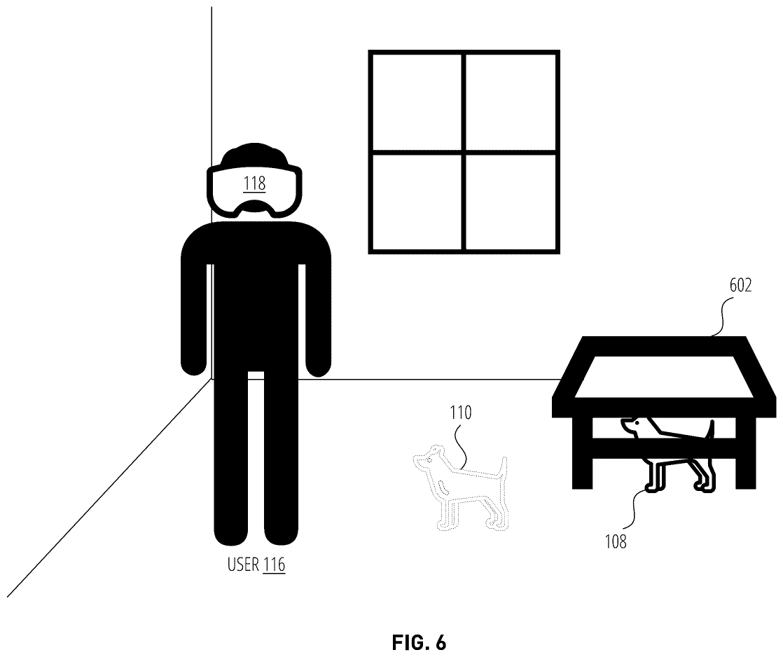

In some embodiments, the combined reality system 100 may implement a diminished reality (DR) feature. For example, while the combined reality system 100 can exist in a full virtual reality environment that completely covers the user's 116 sense of sight, a more realistic form of CR includes augmented reality or mixed reality where virtual representations 110 of objects 106 are shown intertwined with the user's actual physical environment (as shown for example in FIG. 1B). Continuing the service dog example, the user 116 may see their own home with the virtual dog bounding around inside it (see, e.g., FIG. 6).

To accomplish this mixing of reality in a user device 120 where a physical representation 108 is present, the physical representation 108 may be hidden from a user's 116 field of view 124 to enhance the immersion. To do so, the combined reality system 100 implements diminished reality (DR) that removes and hides objects from a user's sight. In this way, the physical representation 108 can be hidden from view so that the user 116 only sees the virtual representation 110 while still being able to touch and feel the physical representation 108. In some embodiments, the physical representation and virtual representation occupy the same position. In some embodiments, the combined reality system 100 will hide the physical representation 108 (see, e.g., FIG. 6 where the user 116 is separated from the user 116 by a physical object 602). When the virtual representation 110 is separated from the location of the physical representation 108, hiding the physical representation 108 becomes more important to maintaining the combined reality simulation 114.

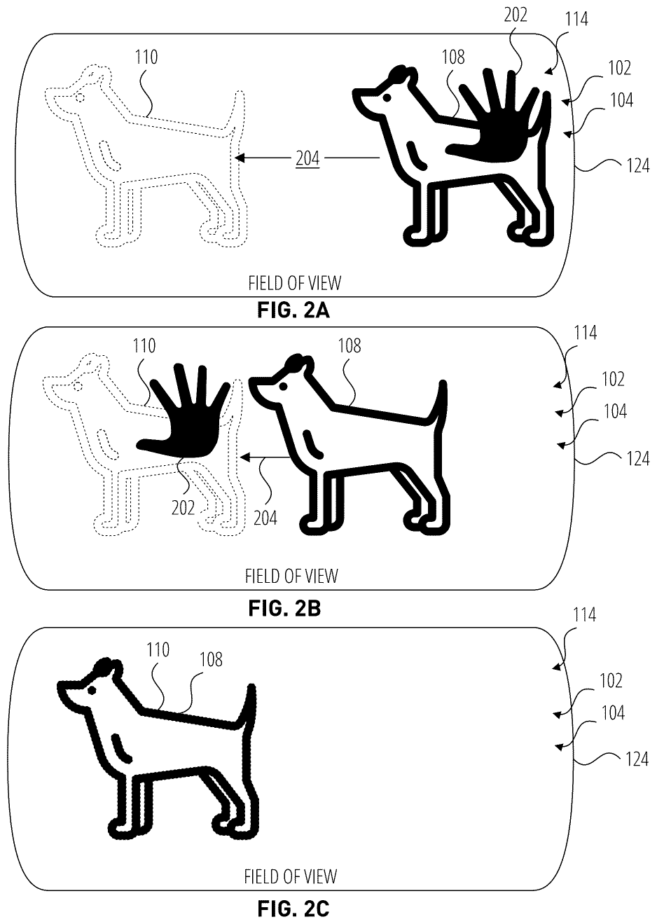

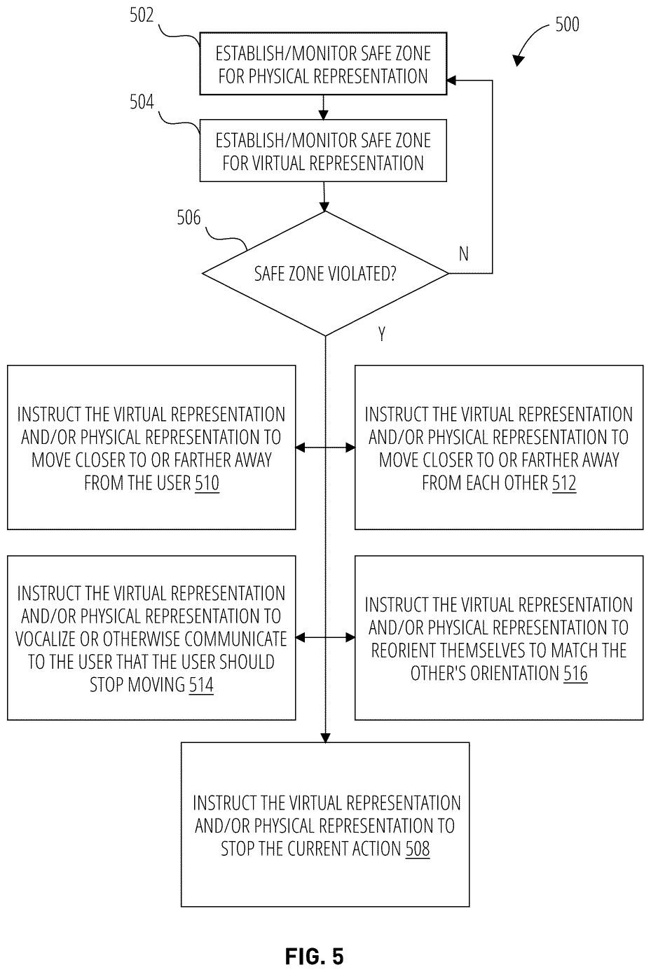

As shown for example in FIG. 2A-FIG. 2C and FIG. 5, the combined reality system 100 provides methods to prevent loss of combined immersion (LOCI). A LOCI event occurs when one or more of the following conditions occurs: 1) the user 116 feels a physical representation 108 where none should be, according to the virtual representation 110 (e.g., FIG. 2A where the user's 116 hand 202 pets the physical representation 108 but the virtual representation 110 is elsewhere); 2) does not feel a physical representation 108 where one would be expected according to the virtual representation 110 (e.g., FIG. 2B where the user's 116 hand 202 attempts to pet the virtual representation 110 when the physical representation 108 is elsewhere); or 3) the physical representation 108 and the virtual representation 110 become separated from one another in the combined reality simulation 114.

In various examples a LOCI event may occur when virtual representation 110 is bounding toward the user 116 and jumps up on the user 116 but no matching physical sensation is felt. A user 116 reaches out to interact with the virtual representation 110 standing nearby in the virtual world 104, but their hand makes no contact. These are examples similar to that depicted in FIG. 2B.

In other examples similar to FIG. 2A, the virtual representation 110 is on the other side of the room from the user 116. The user 116 starts walking and trips over the physical representation 108 sitting in front of the user 116 and which the user 116 could not see. In another example, a virtual representation 110 is on the other side of the room from the user 116 yet the physical representation 108 leans against the user's 116 legs. A LOCI event is not only a loss of immersion but can cause unsettling feelings and can be a hazard to the user's 116 physical wellbeing.

It is desired to avoid LOCI events. As such, the combined reality system 100 implements a touch proximity correction method 500 described with respect to FIG. 5. Before describing the touch proximity correction method 500 a description of safe zones is informative.

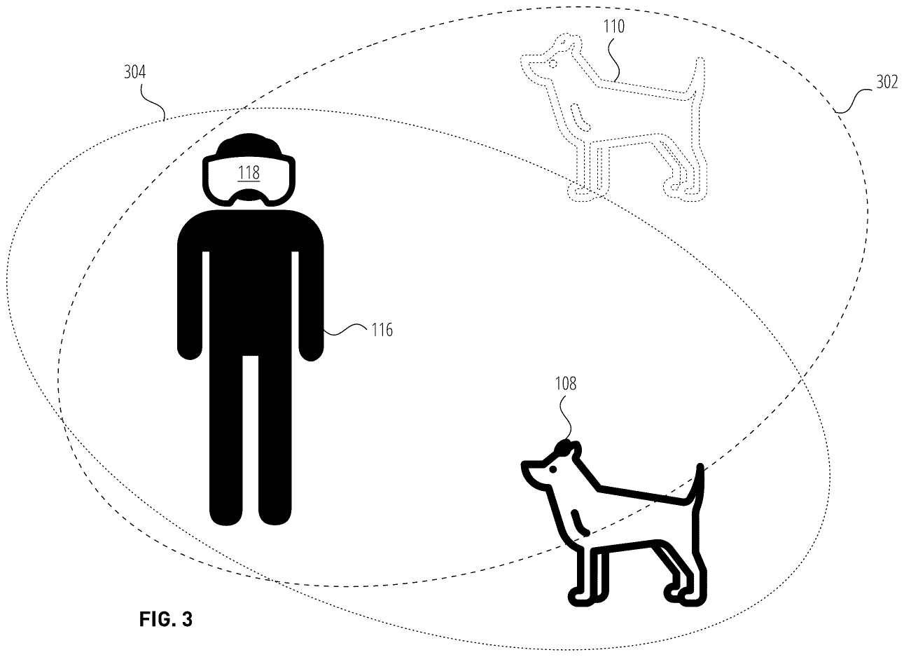

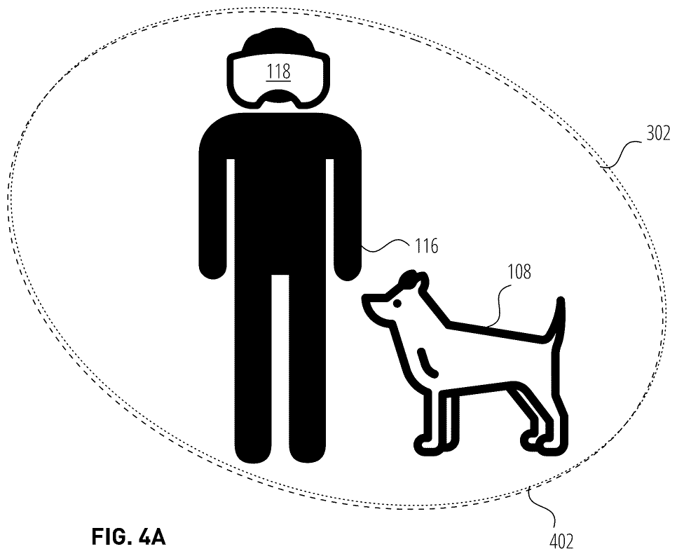

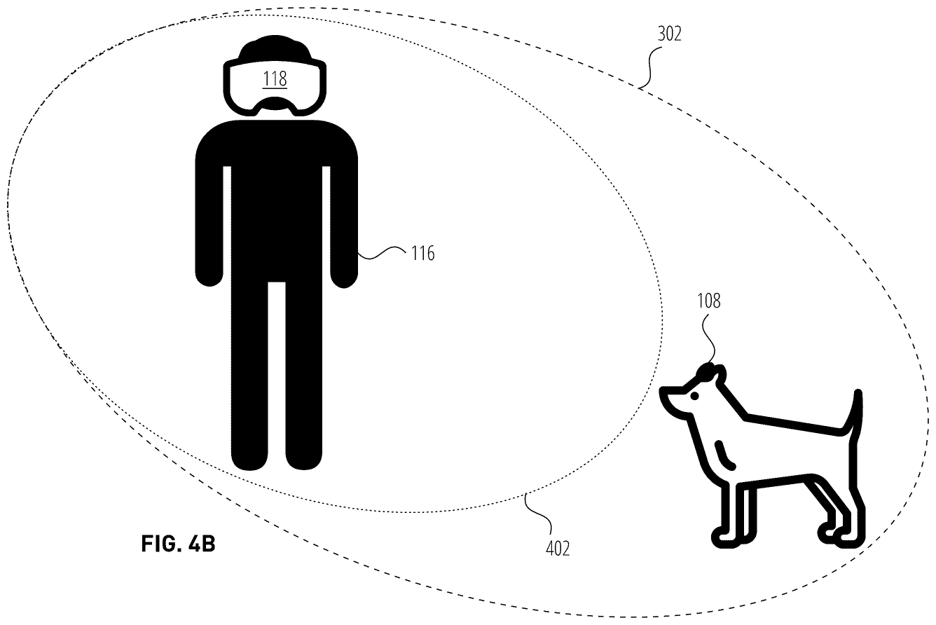

As shown for example in FIG. 3-FIG. 4B an example of a LOCI safe zone is described. For example, a safe zone 302 is established by the combined reality system 100 about the virtual representation 110. Another safe zone 304 is established about the physical representation 108. Either or both of the safe zone 302 and safe zone 304 may at least partially encompass the user 116 and/or one or more of the virtual representation 110 and/or physical representation 108. E.g., the safe zone 302 and safe zone 304 may have a degree of overlap or may be separate from one another.

To avoid LOCI events, the combined reality system 100 calculates and monitors the distance of both the virtual representation 110 and physical representation in relation to the user 116. A safe zone for each of the physical representation 108 and virtual representation 110 can be determined based on the estimated amount of time it would take the other of the virtual representation 110 or physical representation 108 to move to the user 116 in the respective virtual world 104 or physical world 102. The safe zones can be visualized as a band wrapping around the user 116 at some distance. In one example, a calculation of a safe zone dimension or location could include using speed of the respective physical representation 108 or virtual representation 110 and distance from these to the user 116 would result in a circular band, additional calculations such as obstructions along the route could produce a fluid or irregular band with distances of varying length.

In some embodiments, the safe zone is created using “time from user 116” rather than a “distance from user 116”. This difference may be used because the movement speeds of the virtual representation 110 and physical representation 108 will typically not be the same. E.g., a virtual representation 110 can move as fast as the refresh rate of the display 706, while a physical representation 108 speed is defined by the physical attributes of the actuators by which it moves, which are grounded in the laws of physics of the real physical world 102. For example, the distance of the respective physical representation 108 or virtual representation 110 from the user 116 is converted to the estimated time for the physical representation 108 or virtual representation 110 to move to the user 116 from an initial location.

The virtual representation portion of the safe zone 302 calculation is based on the amount of time it would take the virtual representation 110 to reach the user's 116 location while adhering to the movement speeds designated by the combined reality system 100 (e.g., not teleporting or moving unbelievably fast, which itself can cause a LOCI event). The physical representation portion of the safe zone 304 calculation is based on the amount of time it would take the physical representation 108 to move to the user's 116 location.

For example, a dog virtual representation 110 may be able to run 10 meters per second but the corresponding robotic dog physical representation 108 may have a top speed of 2 meters per second. If this virtual representation 110 were 100 meters away from the user 116, the safe zone 302 would be 10 seconds. If the physical representation 108 is at 10 or more seconds away from the user 116, which would be 20 meters, then the combined reality system 100 and the combined reality simulation 114 are safe from a LOCI event. However, if the physical representation 108 is closer than 10 seconds to the user 116, a LOCI event becomes possible and touch proximity correction method 500 might be activated by a processing element 702 of the combined reality system 100.

The combined reality system 100 controls the movements of and between the virtual representation 110 and physical representation 108 so it can safely determine when safe zone violations are significant. For example, if the combined reality system 100 has a virtual representation 110 (e.g., dog) running in circles, the combined reality system 100 does not have to be concerned when the dog is approaching the user 116 since the combined reality system 100 is also aware that the dog will continue circling and restore the safe zone 302.

Movements by the user 116 are less predictable and so the combined reality system 100 may be more diligent in evaluating safe zone violations due to user 116 movement. The combined reality system 100 does not know what a user's 116 actions will be, e.g., if the user 116 will stop moving or turn around, so the combined reality system 100 should be prepared for the case that the user 116 continues movements that may create a LOCI event, even possibly speeding up actions of the physical representation 108 or virtual representation 110, and stand ready to satisfy desired touch event of the user 116.

In some examples, such as where the user 116 is sitting or lying, the safe zones 302/304 can be expanded by the combined reality system 100 because the combined reality system 100 can assume the user 116 has a higher likelihood of not moving.

The bands produced using the calculations above could result in a thin line on which each of the physical representation 108 and virtual representation 110 should stay. Any deviation from that line could be a breach of the safe zone. To avoid a breach of the safe zones, the physical representation 108 and virtual representation 110 would have to move in unison, which is unnecessary and undesirable.

As shown for example in FIG. 4A and FIG. 4B, to alleviate this problem, the combined reality system 100 calculates one or more thresholds 402 to widen the safe zone 302/304 band. FIG. 4A and FIG. 4B show just the safe zone 302 and the physical representation 108 for simplicity and clarity, but is equally applicable to the safe zone 304, the virtual representation 110 and its respective thresholds 402. The thresholds depend on a variety of factors, including whether the user 116 is near or far away from either of the physical representation 108 or virtual representation 110, whether the physical representation 108 is under cover (see, e.g., FIG. 6), whether the user 116 is moving or stationary, etc.

In some examples, whenever either or both of the physical representation 108 and/or virtual representation 110 is moving toward the user 116, the representation is creating a safe zone violation. Whenever a representation is moving away from the user 116, the moving representation will be causing a violation for the other representation. To avoid excessive and unnecessary movement, the combined reality system 100 establishes safe zone thresholds 402 to create a buffer in which a safe zone violation is deemed acceptable. These thresholds may be different depending on whether the representations are nearby or far away and whether it is the representations that are decreasing the safe zone or the user's 116 own movement affecting the safe zone.

The closer a physical representation 108 or virtual representation 110 is to the user 116, the more aligned the virtual representation 110 and physical representation 108 should be to avoid a LOCI event. For example, if a representation is within arm's length of the user 116, both representations should be in the same physical location with the same orientation (see, e.g., FIG. 2C). If the virtual representation 110 moves, such as a dog walking around the user's 116 legs, the physical representation 108 needs to match the virtual representation's 110 movements and keep a nearly exact or very tight safe zone. In this situation, the safe zone has virtually no threshold and movement should be synchronized. See, e.g., FIG. 4A.

When a virtual representation is far away from the user 116, such as 100 meters away, a violation of the safe zone is less dangerous. If the virtual representation 110 is 10 seconds away, the physical representation 108 doesn't also need to be 10 seconds away. It could be safe from LOCI at 3 seconds away. Ignoring the situation where the user is trying to upset the system and create a LOCI, the physical representation 108 can simply keep maneuvering away from the user 116 to keep a safe distance. See, e.g., FIG. 4B where the physical representation 108 can maneuver within the band between the safe zone 302 and the threshold 402 without creating a LOCI event.

These thresholds may include gradients within the safe zone 302/safe zone 304 bands. Close to the optimum line is a gradient of “low risk” where the physical representation 108 and virtual representation 110 can move at normal speeds to respond to user 116 movements. Where the physical representation 108 or virtual representation 110 are further away from the user 116, there may be a medium risk of a LOCI event, and the physical representation 108 and/or virtual representation 110 might have to move at a heightened speed if the user 116 begins moving toward one of the physical representation 108 and/or virtual representation 110. At further distances from the user 116 still, the physical representation 108 and/or virtual representation 110 may have to move at their highest possible speeds to avoid a LOCI event. These gradients may be tuned or adjusted based on known or assumed maximum speeds of any of the user 116, the physical representation 108, and/or the virtual representation 110. The combined reality system 100 may account for one or more characteristics of the user's 116 movement, such as whether the user 116 tends to move smoothly or suddenly, if the user 116 has tremors such as may be caused by a medical condition like Parkinson's Disease or the like, or if the user 116 is prone to fainting or falling.

Where the movement of the user 116, the physical representation 108, and/or the virtual representation 110 will violate the safe zone 302/304 and/or the threshold 402 (or other thresholds), the combined reality system 100 may execute a touch proximity correction method 500, which monitors the proximity of the user 116, physical representation 108, and virtual representation 110 with respect to one another via the safe zones to execute corrections to avoid LOCI events.

FIG. 5 illustrates an example touch proximity correction method 500 for preventing and/or correcting LOCI events of the combined reality system 100. Although the example touch proximity correction method 500 depicts a particular sequence of operations, the sequence may be altered without departing from the scope of the present disclosure. For example, some of the operations depicted may be performed in parallel or in a different sequence that does not materially affect the function of the touch proximity correction method 500. In other examples, different components of an example device or system that implements the touch proximity correction method 500 may perform functions at substantially the same time or in a specific sequence.

According to some examples, the touch proximity correction method 500 includes establishing/monitoring a safe zone 302 for the physical representation 108 at operation 502. The safe zone 302 may be calculated as described with respect to FIG. 3. The location of any of the user 116, the physical representation 108, or the virtual representation 110 may be monitored by the combined reality system 100 in the operation 502, such as by one or more sensors 714 (see, FIG. 7 and accompanying description).

According to some examples, the touch proximity correction method 500 includes establishing/monitoring a safe zone 304 for the virtual representation 110 at operation 504. The safe zone 304 may be calculated as described with respect to FIG. 3. The location of any of the user 116, the physical representation 108, or the virtual representation 110 may be monitored by the combined reality system 100 in the operation 504, such as by one or more sensors 714 (see, FIG. 7 and accompanying description).

According to some examples, the touch proximity correction method 500 includes a determination of whether a safe zone has been violated at operation 506. This determination may be made as described with respect to FIG. 3-FIG. 4B.

If no violation occurs, the touch proximity correction method 500 returns to the operation 502 and/or operation 504 and the combined reality system 100 continues to monitor the safe zones and their thresholds.

If a violation does occur, the combined reality system 100 may execute one or more of the operations 508, the operation 510, the operation 512, the operation 514, and/or the operation 516 in any order, overlapping execution, or simultaneously.

According to some examples, the touch proximity correction method 500 includes instructing the virtual representation 110 and/or physical representation 108 to stop the current action at operation 508. For example, the combined reality system 100 may cause the physical representation 108 and/or virtual representation 110 to stop moving.

According to some examples, the touch proximity correction method 500 includes instructing the virtual representation 110 and/or physical representation 108 to move closer to or farther away from the user at operation 510, in either the physical world 102 or the virtual world 104 as appropriate for the respective physical representation 108 or virtual representation 110.

According to some examples, the touch proximity correction method 500 includes instructing the virtual representation 110 and/or physical representation 108 to move closer to or farther away from each other at operation 512. As shown for example in FIG. 2A, the physical representation 108 may be instructed to move toward the virtual representation 110 in a direction 204, while the virtual representation 110 is instructed to stop moving. The operation 512 may continue as the physical representation 108 approaches the virtual representation 110 as shown for example in FIG. 2B. The operation 512 may terminate when the physical representation 108 and virtual representation 110 merge, as shown for example in FIG. 2C. In other examples, the virtual representation 110 may be instructed to move toward the physical representation 108 which is instructed to stop moving. In other examples, still, the physical representation 108 and virtual representation 110 may be instructed to move to a meeting point at which neither of the physical representation 108 or virtual representation 110 are located when the operation 512 begins.

According to some examples, the touch proximity correction method 500 includes instructing the virtual representation 110 and/or physical representation 108 to vocalize or otherwise communicate to the user 116 (e.g., issue a visual, touch, or auditory alert) that the user 116 should stop approaching either of the virtual representation 110 or the physical representation 108 at operation 514. For example, the combined reality system 100 may instruct the virtual representation 110 and/or physical representation 108 to vocalize or otherwise communicate to the user 116 that the user 116 should stop their current action or give them instructions that would instruct the user 116 to stop approaching the physical representation 108. Note that the user may be unaware of the location of the physical representation 108 and so instructing the user 116 to stop moving toward the physical representation 108 may not, by itself, correct the LOCI event. For example, the combined reality system 100 may create a distraction in the combined reality simulation 114 with the intention of interrupting the user's 116 approach to the virtual representation 110 and/or physical representation 108.

According to some examples, the touch proximity correction method 500 includes instructing the virtual representation 110 and/or physical representation 108 to reorient themselves to match the other's orientation at operation 516. For example, if the physical representation 108 and virtual representation 110 are in the same location but facing different (e.g., opposite) directions, the combined reality system 100 may instruct one or both of the physical representation 108 or virtual representation 110 to move or stop moving until the orientations of the physical representation 108 and virtual representation 110 are aligned.

In some embodiments, the touch proximity correction method 500 may not execute any of the of the operation 508 through operation 516 such as is the case when the physical representation 108 is out of sight or reach of the user 116. See, e.g., FIG. 6.

FIG. 6 shows an example of using the combined reality system 100 where the physical representation 108 is out of reach or sight of the user 116. For example, the physical representation 108 may place itself (e.g., in response to a command from the system 100) under physical object 602 such as a table, into a storage container, or other safe location. In this example a safe zone violation does not occur even if the user 116 approaches the physical representation 108, because the user 116 will collide with the physical object 602 before the user 116 makes unexpected contact with the physical representation 108. This is typically a safer situation for the user 116, as the physical object 602 like a table does not move on its own and its location is known to the user 116, unlike the physical representation 108 which can move autonomously and whose location may not be apparent to the user 116. Barring the user 116 climbing under the table, the physical representation 108 can maintain its close proximity indefinitely. In another example, the physical representation 108 can have a designated storage area that can be closed (and possibly locked) while physical sensation of the physical representation 108 is not desired so that the physical representation 108 doesn't have to respond to safe zone violations. Such examples provide energy conservation benefits as well. In this example, most distances more than a few steps away from the user 116 are safe for the virtual representation 110.

FIG. 7 is a simplified block diagram of components of a computing system 700 of the combined reality system 100, such as the server 122, the user device 120, or a VR device 118, etc. For example, the processing element 702 and the memory component 708 may be located at one or in several computing systems 700. This disclosure contemplates any suitable number of such computing systems 700. For example, the server 122 may be a desktop computing system, a mainframe, a blade, a mesh of computing systems 700, a laptop or notebook computing system 700, a tablet computing system 700, an embedded computing system 700, a system-on-chip, a single-board computing system 700, or a combination of two or more of these. Where appropriate, a computing system 700 may include one or more computing systems 700; be unitary or distributed; span multiple locations; span multiple machines; span multiple data centers; or reside in a cloud, which may include one or more cloud components in one or more networks. A computing system 700 may include one or more processing elements 702, an input/output I/O interface 704, one or more external devices 712, one or more memory components 708, and a network interface 710. Each of the various components may be in communication with one another through one or more buses or communication networks, such as wired or wireless networks, e.g., the network 112. The components in FIG. 7 are exemplary only. In various examples, the computing system 700 may include additional components and/or functionality not shown in FIG. 7.

The processing element 702 may be any type of electronic device capable of processing, receiving, and/or transmitting instructions. For example, the processing element 702 may be a central processing unit, microprocessor, processor, or microcontroller. Additionally, it should be noted that some components of the computing system 700 may be controlled by a first processing element 702 and other components may be controlled by a second processing element 702, where the first and second processing elements may or may not be in communication with each other.

The I/O interface 704 allows a user to enter data in to computing system 700, as well as provides an input/output for the computing system 700 to communicate with other devices or services. The I/O interface 704 can include one or more input buttons, touch pads, touch screens, and so on. In some embodiments, the VR device 118 includes a tracking system such as a head tracking system in communication with the I/O interface 704 that detects head movements of the user 116 using sensors 714 that detect location, orientation, distance or proximity of the user 116, the physical representation 108, and/or the virtual representation 110 with respect to each other and/or portions of the physical world 102 and/or virtual world 104. Some non-limiting examples include gyroscopes, accelerometers, magnetometers, global positioning systems, or motion capture systems allowing for real-time or near real-time adjustment of a displayed scene of the virtual world 104 based on user 116 orientation and position. In some embodiments, the VR device 118 includes a tracking system such as a hand tracking system in communication with the I/O interface 704 such as a controller of glove including one or more sensors 714 to enable the user 116 to interact with and manipulate objects such as the virtual representation 110 within the combined reality simulation 114 e.g., by using gestures and movements. In some embodiments, the VR device 118 includes an audio output device in communication with the I/O interface 704 such as a built-in speakers or external audio devices like earphones (wired or wireless) to deliver sound that enhances immersion of the user 116 in the virtual world 104 by simulating sounds coming from various directions in the virtual environment. For example, the VR device 118 may simulate sounds from the virtual representation 110.

The external device 712 are one or more devices that can be used to provide various inputs to the computing systems 600, e.g., mouse, microphone, keyboard, trackpad, sensing element (e.g., motion sensor, proximity sensor, light detector, etc. The external devices 712 may be local or remote and may vary as desired.

The memory components 708 are used by the computing system 700 to store instructions for the processing element 702 such as the virtual world 104, the virtual representation 110, a user interface, as well as store data, such as executable program instructions, user preferences, alerts, etc. The memory components 708 may be, for example, magneto-optical storage, read-only memory, random access memory, erasable programmable memory, flash memory, or a combination of one or more types of memory components.

The network interface 710 provides communication to and from the computing system 700 to other devices. The network interface 710 includes one or more communication protocols, such as, but not limited to Wi-Fi, Ethernet, Bluetooth, etc. The network interface 710 may also include one or more hardwired components, such as a Universal Serial Bus (USB) cable, or the like. The configuration of the network interface 710 depends on the types of communication desired and may be modified to communicate via Wi-Fi, Bluetooth, etc.

The display 706 provides a visual output for the computing system 700 and may be varied as needed based on the device. The display 706 may be configured to provide visual feedback to the user 116 and may include a liquid crystal display screen, light emitting diode screen, plasma screen, or the like. In some examples, the display 706 may be configured to act as an input element for the user 116 through touch feedback or the like. In many embodiments, the VR device 118 includes one or more displays 706. The display 706 may be high-resolution screens located in front of the user's 116 field of view 124, providing a stereoscopic 3D visual output by presenting slightly different images to each eye.

The disclosed systems and methods provide a number of benefits. For example, as VR devices 118 become slimmer, lighter, and more comfortable to wear, people may start wearing them more often. Eventually the VR devices 118 will become like today's mobile phones: with people everywhere, they go and/or on at all times. Once that occurs for VR devices 118, adoption of the combined reality systems 100 herein will permeate the society.

Similarly, as robots become more available and affordable, many people will be resistant to having robots constantly in their life, replacing functions that humans have handled for millennia. The systems and methods of this disclosure will help humans overcome that resistance and accept robots into their lives. For example, where a user 116 is a mother who misses her son (another user 116) who works on the other side of the world and they rarely get to see each other in person. Using the disclosed systems and methods, the mother and son can sit in the same room, virtually appearing to the other. The mother can pat her son's hand, tell him she is proud of him, talk about their lives, and hug when it's time to end the combined reality simulation 114. While a robot will be the physical thing the mother and son are touching, the immersion will be so believable that the mother may feel like she was actually touching her son. The mother will also know that on the other end of the call, her son's physical representation 108 is letting her son feel the touch of her hand on his and the hug with which they leave each other.

Similarly, people may find it off-putting for robots to perform their routine consultations and examinations (e.g., a doctor, tax consultant, attorney, or massage therapist). The systems and methods of the present disclosure will help ease that transition as people will see a realistic person as their virtual representation 110 handling their interaction and not a robot.

The embodiments and benefits of the present disclosure are vast, especially for human interactions. Therapeutics, social interactions, medical interventions, elderly care, companionship, and sports are some of the many possible applications.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A combined reality system comprising:
a physical representation of an object capable of physical interaction with a user;
a virtual reality device including a processing element and configured to display a virtual representation of the object, wherein:
the processing element is configured to merge the physical representation and the virtual representation to create a combined reality simulation.

2. The combined reality system of claim 1, wherein the processing element is configured to execute a touch proximity correction method to prevent loss of combined immersion events by monitoring proximity and adjusting interactions between the user, the physical representation, and the virtual representation.

3. The combined reality system of claim 1, wherein the processing element is configured calculate a safe zone based on the estimated time for the virtual representation or physical representation to reach a location of the user.

4. The system of claim 1, wherein the processing element adjusts a speed of the virtual representation speed to match a movement capability of the physical representation.

5. The system of claim 1, further comprising a sensor configured to detect a movement of the user and adjust movements of at least one of the virtual representation or the physical representation in response to the detected movement.

6. The system of claim 1, wherein the physical representation includes a heat source configured to simulate a temperature of the object.

7. The system of claim 1, wherein the processing element is configured to establish safe zones for the virtual representation and the physical representation relative to the user.

8. The system of claim 7, wherein the processing element is configured to determine a risk gradient within the safe zones for prioritizing corrective actions of the physical representation or the virtual representation.

9. The system of claim 1, wherein the processing element is configured to issue an alert to the user in case of a potential loss of combined immersion event.

10. The system of claim 1, wherein the virtual representation is modifiable based on a user input.

11. The system of claim 10, wherein the modification comprises a visual modification.

12. A method for providing an immersive combined reality experience, comprising:
displaying, via a virtual reality device, a virtual representation of an object;
providing, via the virtual reality device, a physical representation of the object capable of a physical interaction with a user;
merging the virtual representation and physical representation to create a combined reality simulation.

13. The method of claim 12, further comprising monitoring and correcting proximity between the user, the physical representation, and the virtual representation to prevent a loss of combined immersion event.

14. The method of claim 12, further comprising:
determining, via the processing element, at least one safe zone based on an estimated time for the virtual representation or physical representation to reach a location of the user.

15. The method of claim 12, determining, via the processing element, at least one safe zone based on an estimated time for the virtual representation or physical representation to reach a location of the other of the physical representation or the virtual representation.

16. A system for avoiding a loss of combined immersion (LOCI) event in a combined reality simulation, comprising:
a user device with a display configured to display a virtual representation of an object;
a physical representation of the object providing resistive force and interactive feedback to the user;
a control system configured to:
establish safe zones for the virtual representation and the physical representation relative to the user, and
dynamically adjust the positions of the virtual representation and physical representation to maintain user immersion.

17. The touch proximity correction method of claim 16, wherein the control system is configured to determine a risk gradient within the safe zones for prioritizing corrective actions of the physical representation or the virtual representation.

18. The touch proximity correction method of claim 16, further comprising: instructing the physical representation to move to a predefined safe location to avoid a LOCI event.

19. A method of avoiding a loss of combined immersion (LOCI) event in a combined reality simulation, comprising:
establishing, via a processing element, a first safe zone with respect to a physical representation of a physical object;
establishing, via the processing element, a second safe zone with respect to a virtual representation of the physical object;
determining, via the processing element, a violation of either the first safe zone or the second zone based on a movement of the physical representation, the virtual representation, or a user of the combined reality simulation.

20. The method of claim 19 further comprising:
instructing, via the processing element, the virtual representation and/or physical representation to move closer to or farther away from the user.
